(19) United States
(12) Patent Application Publication
(10) Pub. No.: US 2012/0037073 A1
(43) Pub. Date: Feb. 16, 2012

(54) ASSEMBLY AND PROCESS INCORPORATING A CONVEYED TEMPLATE SURFACE FOR RECEIVING A SPRAYABLE POWDERIZED FOAM IN ORDER TO CREATE A PLURALITY OF FLEXIBLE PARTS

(76) Inventor: Miguel Linares, BLOOMFIELD HILLS, MI (US)

(21) Appl. No.: 12/855,449

(22) Filed: Aug. 12, 2010

(51) Int. Cl. B05B 13/02; B05C 9/14; B05C 11/00; B05B 15/00

(52) U.S. Cl. 118/696; 118/324; 118/58; 118/620; 118/315

(57) ABSTRACT

An assembly for creating a part from a spray powder foam and which includes either an overhead suspended or floor supported conveyor, from which are supported or suspended a plurality of spaced apart bodies. Each of the bodies exhibits a template surface corresponding to a part to be produced. One or more spray applicators are arranged in either fixed or numerically operated and movable fashion proximate the conveyor. Upon a selected body advancing to a specified location along the conveyor, the applicator issues a powder foam spray across the template surface. The template surface can be pre-heated to facilitate curing or the body can be advanced following spray application into an oven to facilitate part formation and setting.

### FIELD OF THE INVENTION

The present invention is directed to a conveyor process for creating a flexible skin part constructed from a polymeric material. More specifically, the present invention discloses an assembly and process for creating such a flexible part from a spray powder foam applied in a built up fashion upon a template surface.

### BACKGROUND OF THE INVENTION

The prior art is documented with examples of closed mold assemblies for creating a polymeric based part. These typically involve a closed mold defining an inner template part defining surface which comes into contact with an interiorly held volume of a polymeric granulate or liquid material in order to create a finished part of specified thickness.

### SUMMARY OF THE INVENTION

The present invention discloses an assembly for creating a part from a spray powder foam according to either of overhead suspended or floor supported conveyor variants. A plurality of spaced apart bodies are either supported upon a floor conveyor in a first embodiment or suspended by brackets from the overhead conveyor in the second embodiment.

Regardless of the embodiment, each of the bodies exhibit a template surface corresponding to a part to be produced. One or more spray applicators are arranged in either fixed or numerically operated and movable fashion proximate the conveyor.

In operation, and upon a selected body advancing to a specified location along the conveyor, the applicator issues a powder foam spray across the template surface. The template surfaces can each be pre-heated to facilitate curing. Alternatively, the bodies can be successively advanced following spray application into an oven to facilitate part formation and setting and prior to part removal.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustration of a conveyor assembly according to a first embodiment and which includes a plurality of progressively advanced template surfaces and upon which are successively spray applied a layer of a powderized foam;

FIG. 2 is a side cutaway of a selected template surface shown in FIG. 1 illustrating the spray build up process associated with the overhead positioned applicating heads;

FIG. 3 is an illustration of a spray application assembly according to a second embodiment and illustrating a plurality of overhead suspended and conveyed template surfaces which are successively spray coated with a powder foam;

FIG. 4 is an enlarged view illustrating a selected suspended template in FIG. 3 and further illustrating the peel-away removable nature of the built up article;

FIG. 5 is an example of a closed loop process such as is applied to the embodiment of FIG. 1; and

FIG. 6 is a corresponding illustration of a process such as is applied to the embodiment of FIG. 3.

### DETAILED DESCRIPTION OF THE PREFERRED EMBODIMENTS

Referring now to the several illustrations, the present invention is directed to a conveyor process for creating a flexible skin part constructed from a polymeric material. More specifically, the present invention discloses an assembly and process for creating such a flexible part from a spray powder foam applied in a built up fashion upon a template surface.

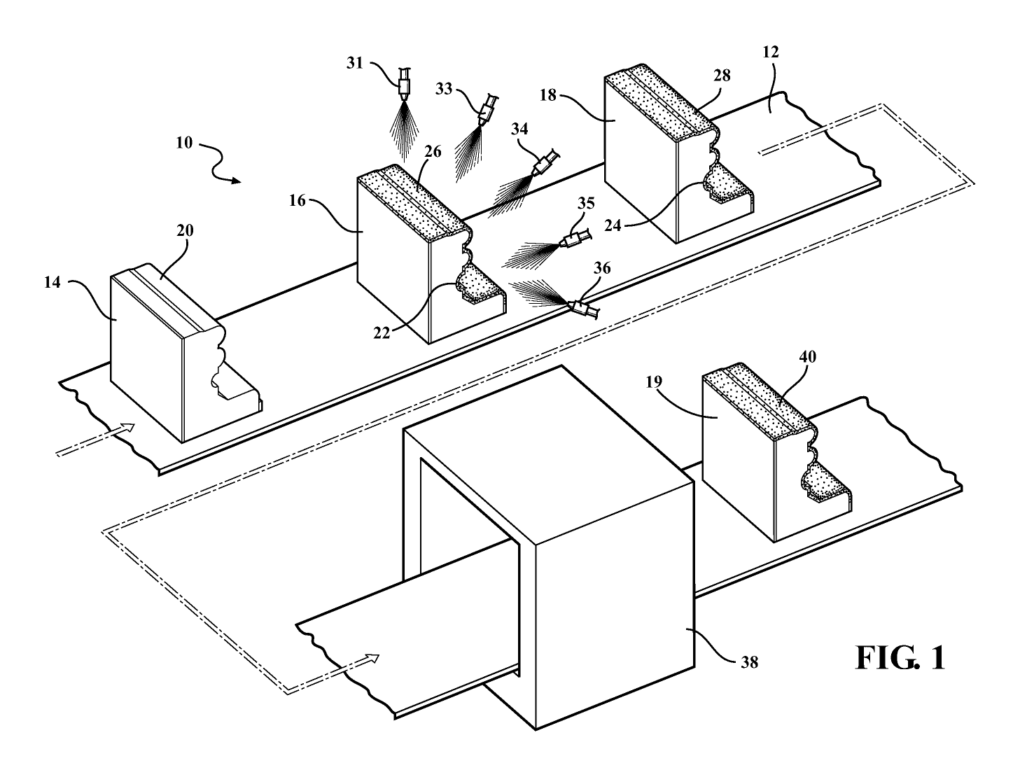

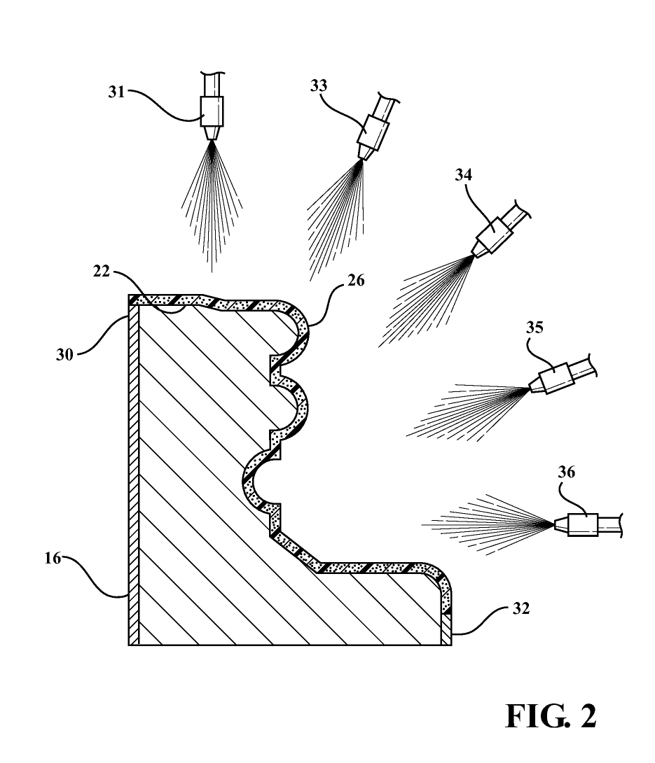

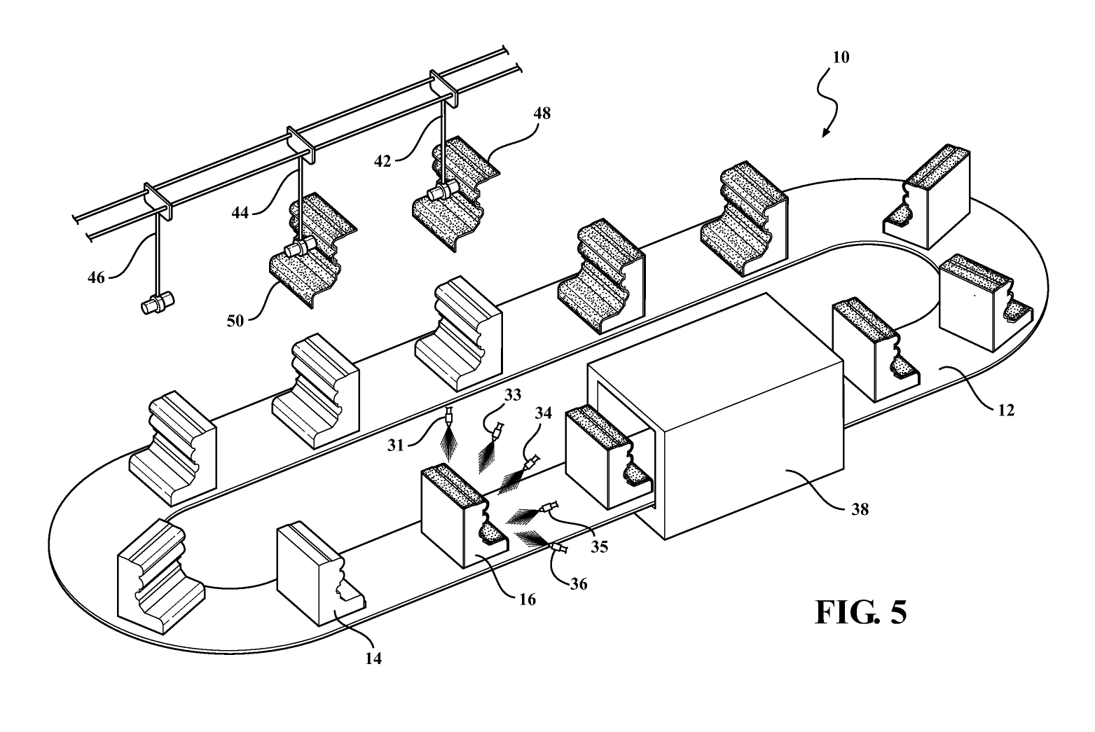

Referring first to FIG. 1, an illustration is generally depicted at 10 of a conveyor assembly according to a first embodiment (see also FIG. 5) and which illustrates a non-limiting example of a continuous carousal 12 or other closed perimeter conveyor or chain drive supported surface and which includes a plurality of bodies 14, 16, 18 et seq. supported in continuously conveyed fashion. Each of the bodies includes an exposed template surface, see respectively at 20, 22, 24 et seq. and upon which are successively spray applied a layer of a powderized foam (see further built up layer 26 in FIG. 2 associated with template surface 22 as well as layer 28 in FIG. 1 associated with template surface 24).

Without limitation, the bodies are each constructed of a durable body, such as a metal, and are supported upon the continually conveying support such that they each exhibit their template surfaces as a negative of a desired part to be (spray) produced. The template part forming surfaces are each further such that they facilitate rapid release (e.g. enabling a spray foam formed part to be quickly and pliably removed) in any fashion desired. The construction of the associated body (with specific reference to the example shown at 16 in the side cutaway of FIG. 2) is further such that formation inhibiting surfaces (such as shown at 30 and 32) can be provided and include such as non-adhering locations surrounding the part adhering surfaces in order to compensate for any unintended overspray.

A plurality of strategically overhead positioned spray nozzles, see for example are depicted at 31, 33, 34, 35 and 36, et seq. and which are placed at specified dimensional positions relative to the template surface (such as following iterative advancement of the selected body to a spray activated position) this optimizing the three dimensional application of powder foam spray in an even fashion across the template surface, thereby resulting in a consistent thickness part being produced. The spray nozzles are representatively shown and are further understood to incorporate any suitable construction which will provide a continuous atomized spray of a desired powderized foam (such as which can also incorporate any desired catalyst or other liquid setting agent) and which is applied to an eventual expanded and cured thickness in order to create a pliable part (such as without limitation associated with vehicle interior trim or the like).

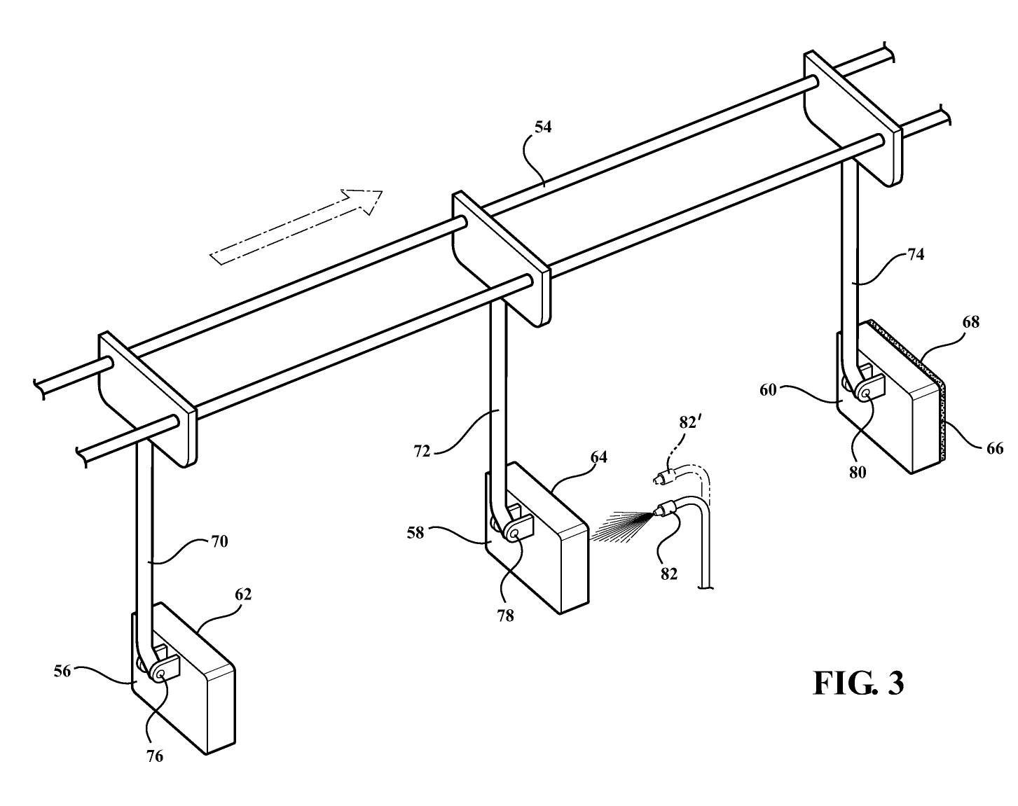

Without further elaboration, it is understood that the nozzle construction of each spray applicator is constructed in a fashion which allows for multiple iterative applications of a build up powder foam with catalysts, without clogging or uneven application, and in such a fashion as to provide any desired range of thickness (such as further contemplating designing in multiple thickness zones in specified areas). It is also envisioned that the chemical composition of the powder foam is further such that it can incorporate any desired composite additives (both polymeric and other), such as in order to exhibit different performance attributes. As will be further described with reference to the embodiment of FIG. 3, the plurality of (static/fixed or adjustable) multiple spray heads can be substituted by a single (or multiple) repositionable (such as via a numeric controller) spray head and in order to provide multiple spray applications via such a numerically controllable and relocate-able head.

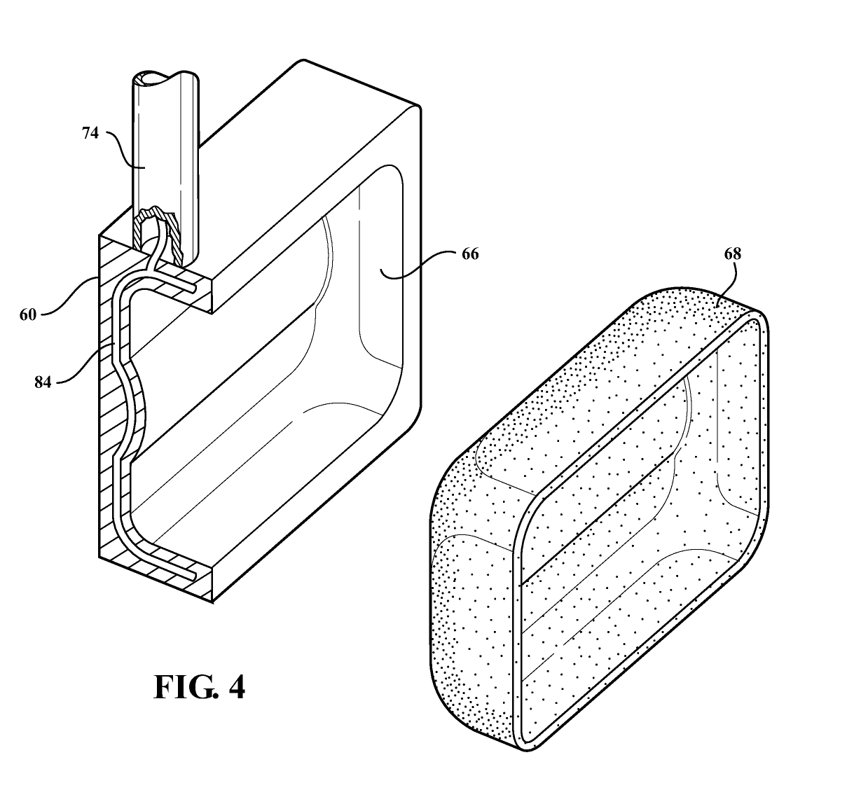

As further depicted in each of FIGS. 1 and 5, an oven/curing station 38 can be positioned at a specified location following the spray applicating heads 31, 33, 34, 35 and 36. Following spray application, the template surface supported bodies are iteratively advanced into the oven station 38 (or are alternately slowly progressed through the oven at a continuous low speed) in order for the spray applied foam to cure or set at a desired temperature and for a desired period of time. Alternately, and as will be illustrated in reference to the selected overhead conveying template supporting body of FIG. 4, a heat generating resistive element can be incorporated into the body a specified distance from the template defining surface and in order to establish a preheated template surface for quickly adhering and setting the foam spray applicant, such as alternate to or in combination with the provision of an oven station.

Following curing, the bodies are progressed from the oven for subsequent removal of the polymeric skins (or parts), such as is depicted by cured skin 40 in FIG. 1 associated with body 19. Removal of the skins can be accomplished in a number of different fashions, these including peeling or otherwise removing from the template defined surface, such as further through the use of a second overhead synchronized conveying/grabbing arms (see at 42, 44, 46 et seq. in FIG. 5 for removing additional depicted skins 48, 50, et seq. from succeeding bodies). Alternately, the skins can be permitted to sufficiently cool and then be manually peeled away, such as by an individual wearing insulated gloves or the like.

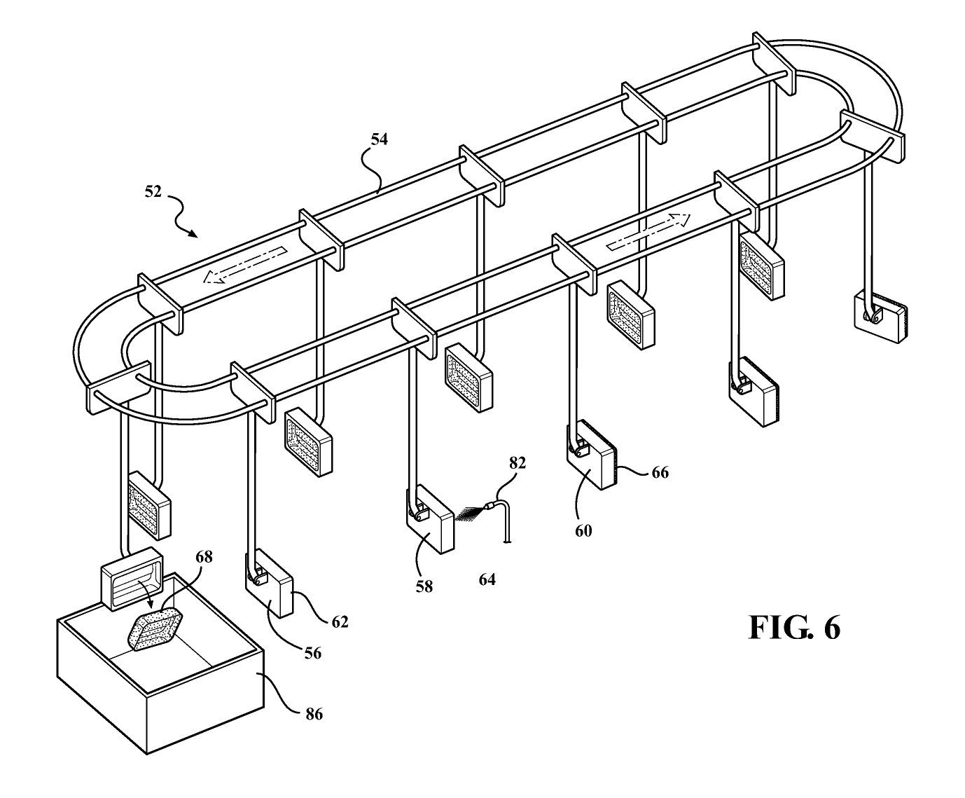

Referring now to FIGS. 3, 4 and 6, a spray application assembly is generally depicted at 52 (see FIG. 6) according to a second embodiment in which is illustrated an overhead rail defining a closed track or elevated support, see at 54, from which are conveyed in a suspended manner, via an associated arm or bracket, a plurality of bodies 56, 58, 60, et. seq. which each exhibit a template surface (respectively 62, 64, 66, et seq.), these again being successively spray coated with a powder foam in order to create a flexible part or skin (further at 68 in FIG. 6) exhibiting a desired thickness. The supporting arms or brackets are further respectively depicted at 70, 72, 74, et seq. and can include hinged or other articulating supports established between the suspended rail 54 and/or a lower support (see further at 76, 78, 80 et seq. in FIG. 3) upon which the template surface defining bodies 62, 64, 66 are supported.

As indicated previously, one or more individual spray applicating heads are provided (see at 82) and which can be either fixed or successively repositionable (in phantom at 82′ in FIG. 3) in order to spray apply a desired coat of powder foam across the template forming surface. As indicated in the embodiment of FIG. 1, a plurality of such as fixed or statically mounted spray heads can also be employed in the variant of FIG. 3 in order to create the desired built up part.

Referring to FIG. 4, an enlarged view illustrates selected suspended template body 60 from FIG. 3 and further illustrates the peel-away removable nature of the built up article or skin 68. Also depicted is the provision of a resistive coil or wire 84 (such as would be revealed in side cutaway) and which, when communicated with an input voltage such as further fed through the overhead conveyor, results in the template surface 66 being heated to a degree sufficient to facilitate timely expansion and curing of the peel away part 68.

Further, and as previously described in FIG. 5, an optional curing booth or oven (not shown) may be alternately or additionally provided and which expedites the setting of the spray applied foam plastic composition. As further depicted in FIG. 6, a bin 86 may be positioned at a location associated with the carousal type assembly an in order to receive finished peel away parts in successive fashion.

Although not shown, a synchronized transfer assembly including again a plurality of individual grabbing arms or the like (see FIG. 5) can be provided for facilitating quick removal of the skins from the individual template forming surfaces, and alternate to individuals removing the skins. Finally, and while illustrating closed carousal type assemblies, it is understood that the conveyor arrangements can be redesigned to incorporate any continuous progressing configuration (such as also contemplating parallel extending inlet and outlet conveyor lines respectively interfacing with opposites ends of an inter-extending spray forming and curing line).

Having described my invention, other and additional preferred embodiments will become apparent to those skilled in the art to which it pertains, and without deviating from the scope of the appended claims.

I claim:

1. An assembly for creating a part from a spray powder foam, comprising:
a conveyor upon which are supported a plurality of spaced apart bodies, each exhibiting a template surface corresponding to a part to be produced; and
at least one spray applicator arranged at a position proximate said conveyor such that, upon a selected body advancing to a specified location, said applicator issues a powder foam across the template surface.

2. The invention as described in claim 1, said conveyor further comprising a continuous carousal.

3. The invention as described in claim 1, said conveyor further comprising an overhead suspended track.

4. The invention as described in claim 1, each of said template surfaces further comprising a metal exhibiting quick properties for ease of removal of the spray formed part.

5. The invention as described in claim 1, further comprising a resistive wire element incorporated into each of said bodies in order to preheat the template surface.

6. The invention as described in claim 1, further comprising a curing oven located at a position along said conveyor subsequent to said spray applicators.

7. The invention as described in claim 1, further comprising a plurality of spray applicators at fixed positions.

8. The invention as described in claim 1, further comprising said applicator operable via a numerical control for providing multiple spray locations.

9. The invention as described in claim 1, further comprising a second overhead synchronized conveying incorporating grabbing arms for removing formed parts from said bodies.

10. The invention as described in claim 1, each of said bodies further comprising spray formation inhibiting surfaces surrounding the template surface.
